(19) United States
(12) Patent Application Publication
(10) Pub. No.: US 2024/0204292 A1
(43) Pub. Date: Jun. 20, 2024

(54) COOLING ARRANGEMENT FOR BILATERAL COOLING A BATTERY UNIT AND BATTERY MODULE FOR A MOTOR VEHICLE

(71) Applicant: AUDI AG, Ingolstadt (DE)

(72) Inventors: Tobias GIER, Ludwigsburg (DE); Philipp SELLE, Heilbronn (DE)

(73) Assignee: AUDI AG, Ingolstadt (DE)

(21) Appl. No.: 18/522,722

(22) Filed: Nov. 29, 2023

(30) Foreign Application Priority Data
Dec. 14, 2022 (DE) 102022133232.2

(51) Int. Cl. H01M 10/6556; H01M 10/613; H01M 10/625; H01M 10/656

(52) U.S. Cl. CPC H01M 10/6556; H01M 10/613; H01M 10/625; H01M 10/656; H01M 2220/20

(57) ABSTRACT

A cooling arrangement for bilateral cooling of a battery unit. The cooling arrangement includes two cooling plates, each having a cooling channel through which a coolant can flow, and two respective connections for supplying and discharging the coolant into and out of the respective cooling channel. The first cooling plate includes a first coupling connection, an integrated first fluid line branch and an integrated second fluid line branch. One of the first connections of the first cooling plate is connected to the first cooling channel of the first cooling plate via the first fluid line branch and is connected to the first coupling connection via the second fluid line branch, and the cooling arrangement includes a first coupling line which fluidly connects the first coupling connection to one of the second connections of the second cooling plate.

### FIELD

The invention relates to a cooling arrangement for bilateral cooling of a battery unit, wherein the cooling arrangement has a first cooling plate for arrangement on a first side of the battery unit, wherein the first cooling plate comprises a first cooling channel through which a coolant can flow and two first connections comprising a first supply connection for supplying the coolant into the first cooling channel and a first discharge connection for discharging the coolant from the first cooling channel, a second cooling plate for arrangement on a second side of the battery unit that is opposite relative to a first direction, wherein the second cooling plate comprises a second cooling channel through which a coolant can flow, and two second connections, comprising a second supply connection for supplying the coolant into the second cooling channel and a second discharge connection for discharging the coolant from the second cooling channel. Furthermore, the invention also relates to a battery module for a motor vehicle.

### BACKGROUND

When cooling battery units, for example battery modules with multiple battery cells, the aim is fundamentally to be able to achieve the most homogeneous possible temperature distribution over such a battery unit. A fundamental problem in this case is usually that the coolant supplied via a supply connection is usually significantly cooler than the coolant which is discharged again via a discharge connection and which has already passed through the cooling channels of the corresponding cooling structure and has thus also absorbed heat from the battery cells. Battery cells that are therefore closer to the discharge connection of such a cooling structure than those that are closer to the supply connection can no longer be cooled as efficiently. This can be counteracted by suitable cooling channel routing. Another problem is the space-efficient design of a distribution unit in order to supply the coolant to the cooling plates and to discharge it from them again. This often requires numerous pipes or hoses, which require a lot of space on the side of such a battery unit.

A bilateral cooling option is described, for example, in DE 102 38 235 A1. In particular, this is a cooling structure for an energy storage device that comprises round cells that are arranged next to each other in multiple rows. The cooling or heat exchanger structure comprises heat exchanger channels that run between the rows of these round cells.

Here too, however, the coolant supply and discharge at the edge of the energy storage is implemented by a very complex distribution structure that requires a lot of installation space.

### SUMMARY

The object of the present invention is to provide a cooling arrangement and a battery module which enable the most efficient cooling of a battery unit and which also allow a particularly simple and space-efficient design of the coolant supply and discharge to and from the cooling plates. In addition, an object of advantageous developments of the invention is to enable the temperature control of the battery unit to be as homogeneous as possible.

This object is achieved by a battery arrangement and a battery module having the features according to the respective independent claims. Advantageous embodiments of the invention are the subject matter of the dependent claims, the description, and the figures.

A cooling arrangement according to the invention for bilateral cooling of a battery unit has a first cooling plate for arrangement on a first side of the battery unit, wherein the first cooling plate comprises a first cooling channel through which a coolant can flow and two first connections, comprising a first supply connection for supplying the coolant into the first cooling channel and a first discharge connection for discharging the coolant from the first cooling channel. In addition, the cooling arrangement comprises a second cooling plate for arrangement on a second side of the battery unit which is opposite relative to a first direction, wherein the second cooling plate comprises a second cooling channel through which a coolant can flow, and two second connections, comprising a second supply connection for supplying the coolant into the second cooling channel and a second discharge connection for discharging the coolant from the second cooling channel. The first cooling plate comprises a first coupling connection, an integrated first fluid line branch and an integrated second fluid line branch, wherein one of the first connections is connected to the first cooling channel via the first fluid line branch and is connected to the first coupling connection via the second fluid line branch, and wherein the cooling arrangement comprises a first coupling line which fluidly connects the first coupling connection to one of the second connections of the second cooling plate.

The invention is based on several findings: On the one hand, it is very advantageous to cool a battery unit on both sides, since this not only allows a significantly higher overall cooling capacity to be provided for cooling the battery unit, but also because this results in a significantly more homogeneous temperature distribution within the battery unit leaves. When using two cooling plates, as is the case here, in order to achieve such bilateral cooling of a battery unit, it is therefore necessary to be able to supply a coolant to both plates. It is also very advantageous if both plates are fed with equally cold coolant via their respective supply connections. In other words, the coolant supplied to the second plate should not have first passed through the first cooling plate, as this would significantly reduce the cooling performance and would also be disadvantageous for a homogeneous temperature distribution within the battery unit. Accordingly, it is therefore advantageous to be able to fluidly connect both the first supply connection of the first cooling plate and the second supply connection of the second cooling plate, for example, equally to a main supply connection. Appropriate connections must also be provided for coolant discharge. This typically requires numerous junctions and/or branches. For example, a main supply line could be provided, from which the corresponding branch points extend for coupling to the respective supply connections. However, such a design is extremely expensive, complex and also requires a lot of space. Above all, the invention is based on the realization that this complexity can be significantly reduced if such a branch is not implemented through an external supply line, or analogously, when the coolant is discharged, through an external discharge line or collecting line, but rather if such a branch can also be implemented directly in one of the cooling plates, in the present case in the first cooling plate. For example, the cold coolant can be supplied to the first cooling plate via the first supply connection. The cold coolant supplied then branches according to the first and second fluid line branches and is correspondingly introduced into the first cooling channel of the first cooling plate on the one hand and, on the other hand, supplied via the coupling connection and the coupling line connected thereto to the first supply connection of the second cooling plate. A coolant supply line then only needs to be connected to the first cooling plate via its first supply connection if the coolant supplied can be simultaneously distributed to the first and second cooling plates. For this purpose, only the coupling line needs to be provided between the coupling connection of the first cooling plate and the first supply connection of the second cooling plate. However, this can be designed relatively simply, for example as a pipe or hose. Alternatively or additionally, this can also apply analogously to the coolant discharge from the plates. The first connection, which is therefore connected to the first coupling connection, does not necessarily have to be the first supply connection, but can also be the first discharge connection. Correspondingly, for example, the coolant to be discharged from the second cooling plate can be guided via the second discharge connection and the first coupling line to the first coupling connection of the first cooling plate. This coupling connection is in turn connected to the second discharge connection of the first cooling plate via the second fluid line branch. The coolant to be discharged from the first cooling plate can also be guided from the first cooling channel via the first fluid line branch to the first discharge connection. As a result, the coolant can be discharged in a bundled form from the second and first cooling plates via a common discharge connection, in particular the first discharge connection. In both cases, that is to say both when supplying coolant and when discharging coolant, the corresponding branching or collection points at which the fluid line branches branch out or are brought together can be implemented in the cooling plate itself. This allows a particularly simple and space-saving design of the distribution system for supplying and discharging the coolant. The coolant structures located outside the battery unit can therefore be designed to be significantly more space-saving.

This is particularly advantageous in the case of a crossed flow through the coolant plates, which enables particularly homogeneous temperature control of the battery unit, as will be described in more detail later and is provided according to advantageous embodiments of the invention. With such a crossed flow, it is not the supply connections of the two plates and the two discharge connections of the two plates that are arranged one above the other in the first direction, but rather a supply connection of one plate is arranged above the discharge connection of the other plate and the other discharge connection of one plate is arranged above the supply connection of the other plate. The two supply connections and the two discharge connections are therefore arranged crosswise. In a conventional distribution structure with intersecting pipes or hoses, this requires even more installation space. By integrating the branching into one of the cooling plates as described above, significant installation space can be saved, especially with such a crossed flow.

The invention is preferably used in a battery unit which, for example, has a rectangular base shape. The cooling arrangement is further preferably designed in such a way that the cooling plates are only located on a respective outer side of the battery unit or of the battery cells encompassed thereby and do not extend between battery cells. The battery unit preferably comprises multiple battery cells arranged next to each other in a stacking direction, which can particularly preferably be designed as prismatic or pouch battery cells. The stacking direction is preferably aligned perpendicular to the above-mentioned first direction. When the cooling arrangement is installed as intended in a motor vehicle, the first direction can in particular correspond to a vertical direction of the vehicle. With regard to this intended installation position, one of the two cooling plates lies on an upper side of the battery unit, and the other lies on an underside.

The first and/or second cooling plate can each have a contact side facing the battery unit, which is preferably planar or flat. There should be no structures, elevations or anything similar on this respective contact page. The opposite outer side of the respective cooling plate can optionally have structures that are provided for the formation of the cooling channels. For example, the first cooling plate can be constructed in such a way that it has two metal sheets, one of which is embossed to form the first cooling channel, and in particular also the first and second fluid line branches. The two sheets are joined together in such a way that the first cooling channel as well as the first and second fluid line branch then result in a corresponding cavity between the first and second sheets. The joining is preferably carried out using a roll bonding process. This enables a particularly reliable and robust seal between the two sheets. It is therefore advantageous if the first cooling plate comprises two sheets joined together, at least one of which is embossed to provide the first cooling channel, the first and the second fluid line branch being formed between the two sheets. Incidentally, the second cooling plate can also be designed in the same way, although it does not necessarily have to comprise branching fluid line branches. The embossed sheets provide the outer side of the respective cooling plates. This means that the internal contact sides that face the battery unit can be provided flat.

Furthermore, the first cooling plate can have not only a first cooling channel, but also multiple first cooling channels. These can be designed in the same way as described for the first cooling channel. These first cooling channels can also form a first cooling channel structure as a whole. The multiple first cooling channels can be brought together to the first fluid line branch and in particular also to the third fluid line branch described later at their respective other ends.

In an advantageous embodiment of the invention, the first cooling plate comprises a second coupling connection, an integrated third fluid line branch, and an integrated fourth fluid line branch, wherein the first supply connection is connected to the first cooling channel via the first fluid line branch and is connected to the first coupling connection via the second fluid line branch, wherein the first discharge connection is connected to the first cooling channel via the third fluid line branch and is connected to the second coupling connection via the fourth fluid line branch, wherein the first coupling line fluidly connects the first coupling connection and the second supply connection and wherein the cooling arrangement comprises a second coupling line, which fluidly connects the second coupling connection to the second discharge connection of the second cooling plate.

In this case, the first supply connection of the first cooling plate branches into the first fluid line branch and the second fluid line branch. The coolant can be supplied to the first cooling channel of the first cooling plate via the first fluid line branch, while the supplied coolant can be supplied to the second cooling plate via the second fluid line branch and the coupling connection via the coupling line. The same applies to coolant discharge. The coolant, which has already passed through the second cooling plate, for example, can be supplied to the first cooling plate via the second coupling connection and the second coupling line connected thereto. Via the fourth fluid line branch in the first cooling plate, the coolant, together with that from the third fluid line branch in the first cooling plate, from which the coolant is discharged from the first cooling channel, is then guided to the first discharge connection and discharged therefrom. The coolant is therefore not supplied separately from the second cooling plate to a discharge line, but is first introduced into the first cooling plate via the second coupling line and discharged together with the remaining coolant to be discharged from the first cooling plate via the first discharge connection. In this example, the branch points for the coolant supply and coolant discharge are thus located in the first cooling plate. Alternatively, these can also be arranged in the second cooling plate. It is also conceivable, as explained in more detail later, that one branch point is implemented in the first cooling plate and the other in the second cooling plate. However, it is particularly space-efficient to implement these branching points in the same cooling plate, in this case, for example, in the first cooling plate. This makes it possible, for example, to make the second cooling plate significantly shorter in its longitudinal direction, which can correspond to the stacking direction defined above.

In a further advantageous embodiment, the second cooling plate comprises a second coupling connection, an integrated third fluid line branch and an integrated fourth fluid line branch, wherein the first supply connection is connected to the first cooling channel via the first fluid line branch and is connected to the first coupling connection via the second fluid line branch, wherein the second discharge connection is connected to the second cooling channel via the third fluid line branch and is connected to the second coupling connection via the fourth fluid line branch. Furthermore, the first coupling line fluidly connects the first coupling connection to the second supply connection, wherein the cooling arrangement comprises a second coupling line which fluidly connects the second coupling connection to the first discharge connection of the first cooling plate. In this example, the first coupling connection is now provided in the first cooling plate and the second coupling connection, is not also provided, as described in the exemplary embodiment above, in the first cooling plate, but instead in the second cooling plate. In other words, in the present case one branch is implemented in the first cooling plate and the other of the two branches is implemented in the second cooling plate. Although this also requires a little more installation space than the previously described variant, this design also has great advantages over previous concepts in relation to a reduction in the complexity of the design of the coolant distribution device for coolant supply and discharge. In addition, branching points in the supply lines for supplying the coolant to the cooling plates can be avoided. A supply line can therefore simply be connected to the first supply connection and both cooling plates can be supplied with the coolant via this same connection. A discharge line can also simply be connected to the first discharge connection in the example mentioned above, and to the second discharge connection in the present example, in order to discharge the coolant from both plates simultaneously from the plates via a common connection. Especially when several such modules are arranged next to each other, this leads to an enormous simplification of the coolant supply and discharge device.

The geometry of the cooling plates will be explained below to simplify the description of further exemplary embodiments. It is preferred that the first cooling plate has a first length in a second direction and a first width in a third direction. The second and third directions can be defined perpendicular to one another, and in particular also perpendicular to the first direction defined above. Furthermore, it is preferred that the first cooling plate has a first end region and an opposite second end region with respect to the second direction, and a first plate part and a second plate part which are arranged next to one another in the third direction. In other words, the first cooling plate can be divided into the first and second plate parts as the only two plate parts. The two plate parts can, for example, define two plate halves of the first cooling plate. It is also advantageous if the second cooling plate also has a second length in the second direction and a second width in the third direction, has a third end region with respect to the second direction and an opposite fourth end region, and a third plate part and a fourth Plate part, which are arranged next to each other in the third direction. The third and fourth plate parts can also represent two plate halves of the second cooling plate.

Furthermore, it is preferred that in the first direction the first plate part lies opposite the third plate part, the second plate part lies opposite the fourth plate part, the first end region lies opposite the third end region and the second end region lies opposite the fourth end region.

Based on the above definition, in a further very advantageous embodiment of the invention the first connections are arranged in the first end region and the second connections are arranged in the third end region, and the first and second coupling lines fluidly connect the first and second cooling plates in the first and third end regions to one another. Thus, all components involved in the coolant supply and discharge can advantageously be arranged on the same side of a battery module, namely in the present case the first and third end regions of the two cooling plates, which are directly opposite one another with respect to the first direction.

The arrangement of all supply and discharge connections as well as the coupling connections with the coupling lines arranged thereon on the same side of the battery unit has enormous space advantages and enormously simplifies the coolant line structure for coolant supply and discharge.

In a further advantageous embodiment of the invention, the first cooling channel has a first channel portion which is connected to the first supply connection, in particular via the first fluid line branch, and a second channel portion which is connected to the first discharge connection, in particular via the third fluid line branch, so that a coolant supplied to the first cooling channel via the supply connection first passes through the first channel portion and then through the second channel portion. Furthermore, the first channel portion extends in the first plate part and the second channel portion runs in the second plate part. It is furthermore particularly advantageous if the second cooling channel of the second cooling plate has a third channel portion which is connected to the second discharge connection and a fourth channel portion which is connected to the second supply connection, so that coolant supplied to a second cooling channel via the second supply connection first passes through the fourth channel portion and then passes through the third channel portion, wherein the third channel portion extends in the third plate part and the fourth channel portion in the fourth plate part.

In other words, the respective channel portions through which the colder coolant is supplied and the channel portions through which the already heated coolant is discharged again of the two cooling plates are arranged diagonally to one another or crosswise. The first channel portion of the first cooling channel in the first plate, via which the coolant is supplied, lies with respect to the first direction directly above or below the third cooling channel portion of the second cooling channel of the second cooling plate, via which the heated coolant is discharged from the second cooling plate. Instead, the fourth cooling channel portion, via which the cold coolant is supplied to the second cooling plate, is directly opposite, with respect to the first direction, the second cooling channel portion of the first cooling plate, via which the heated coolant is discharged from the first cooling plate. This cross arrangement allows a particularly homogeneous temperature distribution to be achieved within the battery cells of the battery unit. However, in conventional designs of a coolant distribution structure, it is precisely such a crossing structure that leads to very complex constructions that require a lot of installation space. The present cooling arrangement with branching points provided in the cooling plates themselves leads to enormous space advantages, especially with such a cross-flow. Above all, this can save a lot of installation space in the longitudinal direction, that is, in the direction of the second direction. Through the second fluid line branch, which is, for example, integrated in the first cooling plate and leads to the first coupling connection, a channel guide can also be realized in the direction of the other half of the first cooling plate. In other words, for example, the first supply connection can be arranged in the first plate part of the first cooling plate, if, for example, the first coupling connection, which is connected to the first supply connection via the second fluid line branch, can be arranged in the second plate part of the first cooling plate. The first coupling line can, for example, simply be extended vertically downwards to the second cooling plate, from where the cold coolant can be supplied directly to the fourth cooling channel portion. In other words, this crossover routing of the coolant supply and coolant discharge can be provided simply by the corresponding fluid line branches leading from one half of the plate to the other half of the plate and vice versa. As a result, the coupling lines can again be designed to be particularly simple. In particular, these connections, which thus extend in a straight line with respect to the first direction, can be provided between the cooling plates. In a further advantageous embodiment of the invention, the first supply connection is arranged in the first plate part and the first discharge connection is arranged in the second plate part, the second supply connection is arranged in the fourth plate part and the second discharge connection is arranged in the third plate part. The supply and discharge connections of the first plate are then arranged crosswise corresponding to the supply and discharge connections of the second plate. This makes it easiest to implement crossing coolant supply and discharge.

In a further advantageous embodiment of the invention, the first coupling connection is arranged in the second plate part and is directly opposite the second supply connection, in particular with respect to the first direction, and the second coupling connection is arranged in the first plate part and is directly opposite the second discharge connection, in particular with respect to the first direction. This has the great advantage that, as already mentioned above, the coupling line can be realized as a straight fluidic connection between the two plates aligned parallel to the first direction, just like the second coupling line. The distance between the relevant coupling connection and the opposite connection of the second plate is therefore minimal.

In a further advantageous embodiment of the invention, the first cooling plate provides a first overall flow cross section for the coolant and the second cooling plate provides a second overall flow cross section for the coolant, which differs from the first overall flow cross section, in particular wherein the second overall flow cross section is smaller than the first overall flow cross section. The first cooling plate can therefore be, for example, a primary cooling plate and the second cooling plate can be a secondary cooling plate. However, the cooling plates can also be designed in exactly the opposite way, that is, the second cooling plate can be designed as a primary cooling plate and have a correspondingly larger overall flow cross section than the first cooling plate. The different design of the overall flow cross sections makes it possible, particularly in the present case for the second cooling plate, to provide a smaller second cooling channel, for example in terms of its width. This allows further functionalities to be integrated into the second cooling plate, since the course of the second cooling channel does not take up the entire plate area. Nevertheless, it is also conceivable that both cooling plates are of same design with regard to their overall flow cross sections.

A larger overall flow cross section also allows greater cooling capacity to be effectively provided. More coolant can therefore flow through the first cooling plate per unit of time than the second cooling plate. This is advantageous, for example, if the first side of the battery unit is to be cooled more than the second side or if an additional function is to be integrated into one of the two plates. In particular, this also enables, for example, a venting gas to be discharged through the second cooling plate to a gas discharge channel, specifically through regions of the second cooling plate in which there are no cooling channels.

Furthermore, the invention also relates to a battery module for a motor vehicle having a battery arrangement according to the invention or one of its embodiments, as well as the battery unit. The battery unit can be designed as already described above. For example, the battery unit can be designed as a cell stack with multiple battery cells arranged next to one another in a stacking direction. In addition, the battery cells can be designed, for example, as lithium-ion cells and in particular as prismatic battery cells or pouch cells. Furthermore, the invention also relates to a high-voltage battery for a motor vehicle, wherein the high-voltage battery has one battery module according to the invention or one of its embodiments. Such a high-voltage battery can in particular comprise a plurality of the described battery modules. These can be arranged next to one another in the second direction, for example. For example, the high-voltage battery can have four such battery modules. The four battery modules can, for example, form two pairs of modules. The module pairs can, for example, be mirror-symmetrical with respect to the coolant supply and discharge with respect to a mirror plane arranged between the two modules, which is aligned perpendicular to the second direction. In other words, for example, the two supply connections in the respective first plate can be arranged closer to one another than the two discharge connections of the first plate. Conversely, the two discharge connections in the second plate can be arranged closer to one another than the two supply connections of the two second plates of such a module pair. This mirror-symmetrical arrangement in turn has advantages in terms of coolant supply and discharge.

A motor vehicle having a battery module according to the invention and in particular a high-voltage battery according to the invention or one of its embodiments should also be regarded as included in the invention.

The advantages mentioned for the battery cell arrangement according to the invention and its embodiments thus apply similarly to the battery module according to the invention, the high-voltage battery according to the invention and the motor vehicle according to the invention.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that each have a combination of the features of several of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic representation of a battery module having a cooling arrangement according to an exemplary embodiment of the invention;

FIG. 2 shows a schematic representation of the battery module from FIG. 1 in a plan view;

FIG. 3 shows a schematic and perspective representation of the battery module from FIG. 1 from obliquely below; and

FIG. 4 shows a schematic and perspective representation of the battery module from FIG. 1 in a plan view from the front.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

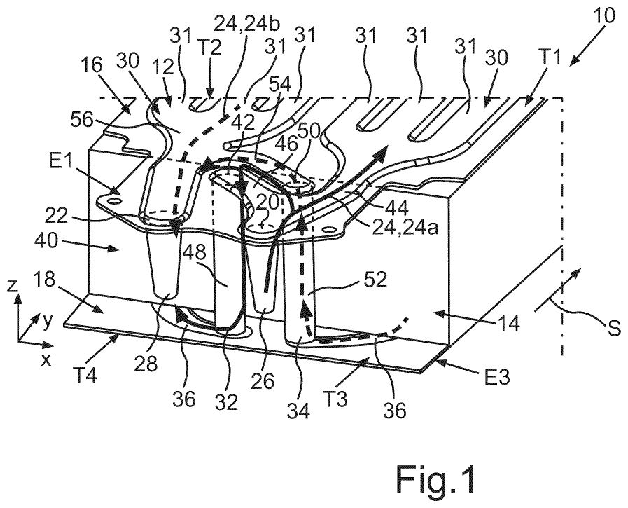

FIG. 1 shows a schematic illustration of a battery module 1 according to one exemplary embodiment of the invention. In particular, only a part of the entire battery module 10 is shown in perspective in FIG. 1. The battery module 10 comprises a cooling arrangement 12 and a battery unit 14. The battery unit 14 can comprise multiple battery cells arranged next to one another in a stacking direction S, which in the present case corresponds to the y-direction shown, and which are not explicitly shown here. The cooling arrangement 12 is designed to cool this battery unit 14 on both sides. For this purpose, the cooling arrangement 12 comprises two cooling plates 16, 18, namely a first cooling plate 16 and a second cooling plate 18. The first cooling plate 16 comprises two connections, namely a first supply connection 20 and a discharge connection 22. The first cooling plate can be supplied via the supply connection 20 16 with a coolant 24, which is illustrated by the arrows. After passing through the first cooling plate 16, the coolant 24 can be discharged from the same via the discharge connection 22. In the present case, a connecting sleeve 26 is arranged on the first supply connection 20, which sleeve can lead, for example, to a coolant supply line and via which the coolant 24 can be supplied. Accordingly, in the present case, a discharge sleeve 28 is arranged on the first discharge connection 22 of the cooling plate 16, which sleeve can be connected to a discharge line or collecting line or can represent part of it and via which the coolant 24 can be discharged. The supplied coolant 24 is typically warmer than the coolant 24 which is discharged from the cooling plate 16. In the present case, the colder coolant stream is designated 24a and the warmer coolant stream is designated 24b. In order for the coolant 24 to pass through the first cooling plate 16, this has a first cooling channel 30, or rather a first cooling channel structure 30 with multiple first cooling channels 31. The coolant 24 can therefore be supplied to the first plate 16 via the supply connection 20, can be introduced into the first cooling channel 31, passes through this and is then subsequently discharged again from the first cooling plate 16 via the discharge connection 22.

The second cooling plate 18 is constructed in a similar manner. This also includes a second supply connection 32 and a second discharge connection 34. The second cooling plate 18 also comprises a second cooling channel 36, to which the coolant 24, which is supplied through the supply connection 32, is supplied and, after passing through it, the coolant 24 is correspondingly discharged again from the discharge connection 34.

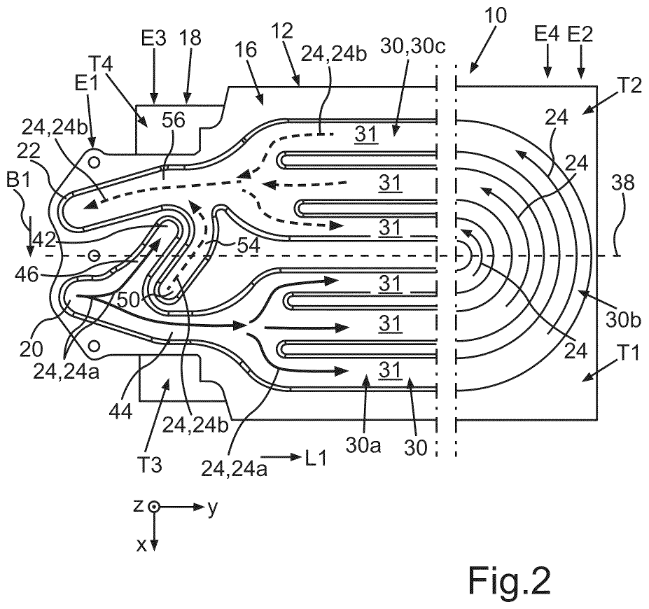

FIG. 2 shows a schematic representation of the battery module 10 of FIG. 1 in a plan view from above, that is to say in the z direction shown. The first cooling plate 16 can have a first length L1 in the y-direction, and a width B1 in the x-direction, as shown. With respect to the y-direction, the first plate has a first end region E1 and an opposite second end region E2. The second underlying plate 18 correspondingly has, with respect to the y direction, a third end region E3, which is opposite the first region E1 of the first plate 16 with respect to the z direction shown, and a fourth end region E4 that is opposite with respect to the y direction, which is opposite the second end region E2 in the z direction. Furthermore, the first plate 16 can be divided in the x direction into a first plate part T1 and a second plate part T2 The boundary between the two plate parts T1, T2 is illustrated schematically by the dashed line 38. In a corresponding manner, the second plate 18 can also be divided into a third plate part T3 and a fourth plate part T4. The two plates 16, 18 are arranged relative to one another in such a way that, with respect to the z-direction, the first plate part T1 lies opposite the third plate part T3 and the second plate part T2 lies opposite the fourth plate part T4. The cooling arrangement 12 is designed such that the coolant 24 supplied via the first supply connection 20 is first supplied to a first cooling channel portion 30a, is transferred in the second end region E2 of the first plate 16 via a deflection portion 30b into a second cooling channel portion 30c of the cooling channel arrangement 30, which extends, in the second plate part T2, back to the discharge connection 22.

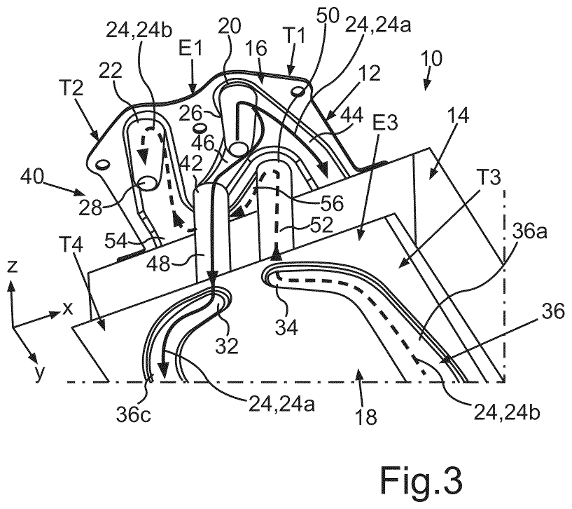

The direction of flow of the coolant 24 in the second cooling plate 18 crosses exactly over the direction of flow of the first cooling plate 16, as can be clearly seen, for example, in FIG. 3. The second cooling channel 36 can also be divided into multiple cooling channel portions, namely a third cooling channel portion 36a and a fourth cooling channel portion 36c. These are also fluidly connected to one another in the fourth end region E4 of the second plate 18 via a corresponding deflection region, which, however, is not shown here. The coolant 24 supplied to the second cooling plate 18 is first supplied to the fourth cooling channel portion 36c in the fourth plate part T4, passes through this and is transferred to the third cooling channel portion 36a in the fourth end region E4, runs back against the y direction, namely in the third plate part T3 of the second cooling plate 18 and is discharged via the discharge connection 34. The flow of the coolant 24 is located in the first cooling plate 16 in the first plate part T1 and with respect to the second cooling plate 18 in the fourth plate part T4, while the return in the first cooling plate 16 is located in the second plate part T2 and in the second plate 18 in the diagonally opposite third plate part T3. The forward and backward flow are therefore crossing in the respective plates 16, 18. This has the great advantage that a significantly more homogeneous temperature distribution can be provided within the battery unit 14. This means that any temperature gradient in or against the x direction can be compensated for.

Such a crossing coolant guiding usually requires a very complex, complex distribution unit for the supply and discharge of the coolant.

The invention or its embodiments now advantageously allow this distribution unit 40 for the coolant supply and discharge to be made much simpler. This can be achieved in particular in that a branch for dividing a coolant supply stream and a coolant discharge stream for supplying the coolant 24 to the two plates 16, 18 and for discharging the coolant 24 from the two plates 16, 18 is not implemented by external lines, but rather is at least partially integrated into the plates 16, 18 themselves. In the present example, this branch is integrated into the first plate 16 and can be clearly seen, especially in FIG. 2, so that this branch will now be explained again below with reference to FIG. 2.

For this purpose, the first cooling plate 16 comprises a first coupling connection 42, an integrated first fluid line branch 44 and an integrated second fluid line branch 46. The integrated first fluid line branch 44 fluidly connects the supply connection 20 to the cooling channel structure 30, and the second fluid line branch 46 fluidly connects the supply connection 20 with the coupling connection 42. This coupling connection 42 is in turn fluidly connected via a coupling line 48 (compare FIGS. 1, 3 and 4) to the second cooling plate 18, in particular to the second supply connection 32. Thus, the coolant 24 supplied to the first plate 16 via the supply connection 20 can be divided via the two fluid line branches 44, 42 and can be introduced, on the one hand, into the first cooling channel 30 of the first cooling plate 16, and supplied via the coupling connection 42 and via the coupling line 48 to the second cooling plate 18 and accordingly introduced into the second cooling channel 36. For the coolant supply, only one connection per battery module 10 is thus required, which is currently connected to the first supply connection 20 and can be designed in the form of the connecting sleeve 26 (see FIG. 1).

The coolant is discharged in a corresponding manner. For this purpose, in the present example, the first cooling plate 16 also comprises a second coupling connection 50, which is fluidly connected to the second cooling plate 18 via a second coupling line 52. In particular, this coupling line 52 leads to the second discharge connection 34 of the second plate 18. The coolant 24, which has passed through the second plate 18, can thus be supplied to the first plate 16 via this second coupling line 52. This second coupling connection 50 is fluidly connected to the discharge connection 22 of the first plate 16 via a further fluid line branch 54. This fluid line branch 54 is also referred to here as the fourth fluid line branch 54. A third fluid line branch 56, which is also integrated into the first plate 16, in turn fluidly connects the first cooling channel 30 or the cooling channel structure 30 to the discharge connection 22. The third and fourth fluid line branches 54, 56 are therefore also merged to a common discharge connection 22 of the first plate 16. The coolant 24 from the second plate 18, which is guided to the discharge connection 22 via the third fluid line branch 54, is therefore brought together with the coolant 24 from the cooling channel structure 30 of the first plate 16 and discharged together via the discharge connection 22.

The branching via these respective fluid line branches can alternatively also be implemented in the second plate 18 instead of in the first plate 16. In addition, it is also conceivable to realize one such branch in the first plate 16 and the other in the second plate 18, although this would require a little more installation space.

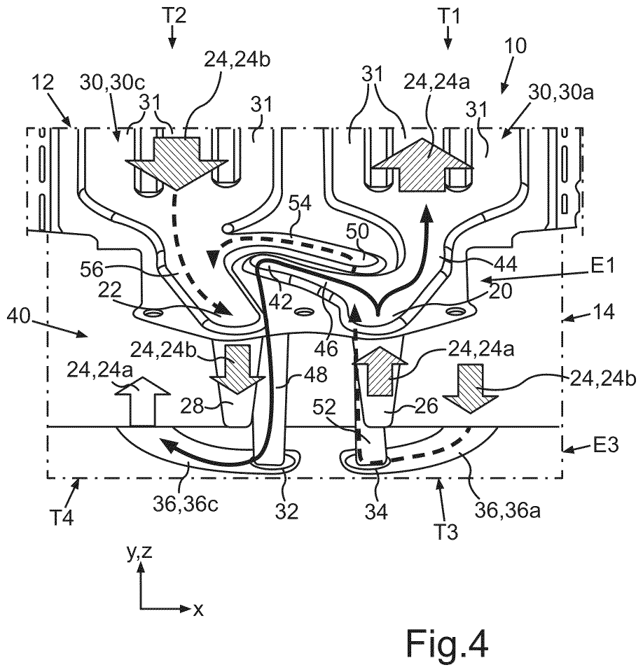

Another great advantage is that, as can also be clearly seen in FIG. 2, the first supply connection 20 is arranged in the first plate part T1, for example, while the first coupling connection 42, which leads to the second plate 18 via the line 48, is arranged in the second plate part T2 of the first plate 16. Likewise, the first discharge connection 22 is arranged in the second plate part T2 of the first plate 16, while the second coupling connection 50 is arranged in the first plate part T1 of the first plate 16. A fluidic connection is, so to speak, guided to the other of the two plate halves T1, T2 via the corresponding fluid line branches 46, 54. In this way, the crossing of the supply and discharge flows for the second underlying plate 18 is realized at the same time. This in turn allows the coupling lines 48, 52 to be designed vertically downwards or parallel to the z-direction, as can be seen, for example, in FIGS. 1 and 4. The external distribution unit 40 can therefore be constructed very simply, as in the present example by the two connecting sleeves 26, 28 for the coolant supply and discharge and the two connecting lines 48, 52 in order to fluidly couple the two plates 16, 18 to one another, once for the coolant supply and once for coolant discharge. The remaining coolant distribution, and in particular the division of the respective coolant paths between the two plates 16, 18, can advantageously be integrated into the plates 16, 18, in the present example into the first plate 16 itself. As a result, no intersecting or branching line structures need be provided for the external distribution unit 40, at least not for each battery module 10.

FIG. 4 again shows a schematic representation of a part of the battery module 10 of FIG. 1, in particular a schematic representation from the front and diagonally above.

A high-voltage battery for a motor vehicle can, for example, include several such battery modules 10. These are preferably arranged next to each other in the x direction. The coolant supply can then take place via a common external coolant supply line to which the individual supply sleeves 26 are connected. The coolant can be discharged via a common collecting line to which the respective discharge nozzles 28 are connected. Per module 10, only one supply connection and one discharge connection need to be provided on such a supply line and a corresponding collecting line. In this way, cross-cooling can be carried out in a particularly efficient and space-saving manner.

Overall, the examples show how the invention can provide a cross-flow coolant plate of a battery system cooled on multiple sides. By designing the cooling channels in the coolant plate, in particular by designing the branching of the cooling channels in the coolant plate, it is possible to remove the coolant flow for the second coolant plate of the battery system and to intersect it at the same time. The crossing results in a homogeneous temperature gradient for the individual cells. Both the upper and lower coolant plates can have the intersection, i.e. the branching of the cooling channels. The manufacturing method for the coolant plate is also freely selectable. Coolant plates manufactured using roll bonding, laser welding, soldering or similar processes can have this structural design.

1. A cooling arrangement for bilateral cooling of a battery unit, comprising:
a first cooling plate for arrangement on a first side of the battery unit, wherein the first cooling plate includes a first cooling channel through which a coolant can flow, and two first connections, including a first supply connection for supplying the coolant into the first cooling channel and a first discharge connection for discharging the coolant from the first cooling channel, a second cooling plate for arrangement on a second side of the battery unit, which is opposite relative to a first direction, wherein the second cooling plate includes a second cooling channel through which a coolant can flow, and two second connections, including a second supply connection for supplying the coolant into the second cooling channel and a second discharge connection for discharging the coolant from the second cooling channel, wherein the first cooling plate includes a first coupling connection, an integrated first fluid line branch, and an integrated second fluid line branch, wherein one of the first connections is connected to the first cooling channel via the first fluid line branch and is connected to the first coupling connection via the second fluid line branch, and wherein the cooling arrangement includes a first coupling line which fluidly connects the first coupling connection to one of the second connections of the second cooling plate.

2. The cooling arrangement according to claim 1, wherein the first cooling plate includes a second coupling connection, an integrated third fluid line branch, and an integrated fourth fluid line branch, wherein the first supply connection is connected to the first cooling channel via the first fluid line branch and is connected to the first coupling connection via the second fluid line branch, wherein the first discharge connection is connected to the first cooling channel via the third fluid line branch and is connected to the second coupling connection via the fourth fluid line branch, wherein the first coupling line fluidly connects the first coupling connection to the second supply connection, and wherein the cooling arrangement includes a second coupling line which fluidly connects the second coupling connection to the second discharge connection of the second cooling plate.

3. The cooling arrangement according to claim 1, wherein the second cooling plate includes a second coupling connection, an integrated third fluid line branch, and an integrated fourth fluid line branch, wherein the first supply connection is connected to the first cooling channel via the first fluid line branch and is connected to the first coupling connection via the second fluid line branch, wherein the second discharge connection is connected to the second cooling channel via the third fluid line branch and is connected to the second coupling connection via the fourth fluid line branch, wherein the first coupling line fluidly connects the first coupling connection to the second supply connection, and wherein the cooling arrangement includes a second coupling line which fluidly connects the second coupling connection to the first discharge connection of the first cooling plate.

4. The cooling arrangement according to claim 1, wherein the first cooling plate has a first length in a second direction and a first width in a third direction, wherein the first cooling plate, with respect to the second direction, has a first end region and an opposite second end region, and a first plate part and a second plate part, which are arranged next to one another in the third direction, wherein the second cooling plate has a second length in the second direction and a second width in the third direction, a third end region with respect to the second direction and an opposite fourth end region, and a third plate part and a fourth plate part, which are arranged next to each other in the third direction, wherein, in the first direction, the first plate part lies opposite the third plate part, the second plate part lies opposite the fourth plate part, the first end region lies opposite the third end region, and the second end region lies opposite the fourth end region.

5. The cooling arrangement according to claim 1, wherein the first connections are arranged in the first end region and the second connections are arranged in the third end region, and the first and second coupling lines fluidly connect to each other the first and second cooling plates in the first and third end regions.

6. The cooling arrangement according to claim 1, wherein the first cooling channel has a first channel portion, which is connected to the first supply connection, in particular via the first fluid line branch, and has a second channel portion, which is connected to the first discharge connection, in particular via the third fluid line branch, so that a coolant supplied to the first cooling channel via the supply connection first passes through the first channel portion and then through the second channel portion, wherein the first channel portion extends in the first plate part and the second channel portion extends in the second plate part, wherein the second cooling channel has a third channel portion which is connected to the second discharge connection, and a fourth channel portion which is connected to the second supply connection, so that a coolant supplied to the cooling channel via the second supply connection first passes through the fourth channel portion and then passes through the third channel portion, wherein the third channel portion extends in the third plate part and the fourth channel portion extends in the fourth plate part.

7. The cooling arrangement according to claim 1, wherein the first supply connection is arranged in the first plate part and the first discharge connection is arranged in the second plate part, the second supply connection is arranged in the fourth plate part and the second discharge connection is arranged in the third plate part.

8. The cooling arrangement according to claim 1, wherein the first coupling connection is arranged in the second plate part and is directly opposite to the second supply connection, in particular with respect to the first direction, and the second coupling connection is arranged in the first plate part and is directly opposite to the second discharge connection, in particular with respect to the first direction.

9. The cooling arrangement according to claim 1, wherein the first cooling plate provides a first overall flow cross section for the coolant and the second cooling plate provides a second overall flow cross section for the coolant, which differs from the first overall flow cross section, in particular which is smaller than the first overall flow cross section.

10. A battery module for a motor vehicle, which has a cooling arrangement according to claim 1 and a battery unit.

11. The cooling arrangement according to claim 2, wherein the first cooling plate has a first length in a second direction and a first width in a third direction, wherein the first cooling plate, with respect to the second direction, has a first end region and an opposite second end region, and a first plate part and a second plate part, which are arranged next to one another in the third direction, wherein the second cooling plate has a second length in the second direction and a second width in the third direction, a third end region with respect to the second direction and an opposite fourth end region, and a third plate part and a fourth plate part, which are arranged next to each other in the third direction, wherein, in the first direction, the first plate part lies opposite the third plate part, the second plate part lies opposite the fourth plate part, the first end region lies opposite the third end region, and the second end region lies opposite the fourth end region.

12. The cooling arrangement according to claim 3, wherein the first cooling plate has a first length in a second direction and a first width in a third direction, wherein the first cooling plate, with respect to the second direction, has a first end region and an opposite second end region, and a first plate part and a second plate part, which are arranged next to one another in the third direction, wherein the second cooling plate has a second length in the second direction and a second width in the third direction, a third end region with respect to the second direction and an opposite fourth end region, and a third plate part and a fourth plate part, which are arranged next to each other in the third direction, wherein, in the first direction, the first plate part lies opposite the third plate part, the second plate part lies opposite the fourth plate part, the first end region lies opposite the third end region, and the second end region lies opposite the fourth end region.

13. The cooling arrangement according to claim 2, wherein the first connections are arranged in the first end region and the second connections are arranged in the third end region, and the first and second coupling lines fluidly connect to each other the first and second cooling plates in the first and third end regions.

14. The cooling arrangement according to claim 3, wherein the first connections are arranged in the first end region and the second connections are arranged in the third end region, and the first and second coupling lines fluidly connect to each other the first and second cooling plates in the first and third end regions.

15. The cooling arrangement according to claim 4, wherein the first connections are arranged in the first end region and the second connections are arranged in the third end region, and the first and second coupling lines fluidly connect to each other the first and second cooling plates in the first and third end regions.

16. The cooling arrangement according to claim 2, wherein the first cooling channel has a first channel portion, which is connected to the first supply connection, in particular via the first fluid line branch, and has a second channel portion, which is connected to the first discharge connection, in particular via the third fluid line branch, so that a coolant supplied to the first cooling channel via the supply connection first passes through the first channel portion and then through the second channel portion, wherein the first channel portion extends in the first plate part and the second channel portion extends in the second plate part, wherein the second cooling channel has a third channel portion which is connected to the second discharge connection, and a fourth channel portion which is connected to the second supply connection, so that a coolant supplied to the cooling channel via the second supply connection first passes through the fourth channel portion and then passes through the third channel portion, wherein the third channel portion extends in the third plate part and the fourth channel portion extends in the fourth plate part.

17. The cooling arrangement according to claim 3, wherein the first cooling channel has a first channel portion, which is connected to the first supply connection, in particular via the first fluid line branch, and has a second channel portion, which is connected to the first discharge connection, in particular via the third fluid line branch, so that a coolant supplied to the first cooling channel via the supply connection first passes through the first channel portion and then through the second channel portion, wherein the first channel portion extends in the first plate part and the second channel portion extends in the second plate part, wherein the second cooling channel has a third channel portion which is connected to the second discharge connection, and a fourth channel portion which is connected to the second supply connection, so that a coolant supplied to the cooling channel via the second supply connection first passes through the fourth channel portion and then passes through the third channel portion, wherein the third channel portion extends in the third plate part and the fourth channel portion extends in the fourth plate part.

18. The cooling arrangement according to claim 4, wherein the first cooling channel has a first channel portion, which is connected to the first supply connection, in particular via the first fluid line branch, and has a second channel portion, which is connected to the first discharge connection, in particular via the third fluid line branch, so that a coolant supplied to the first cooling channel via the supply connection first passes through the first channel portion and then through the second channel portion, wherein the first channel portion extends in the first plate part and the second channel portion extends in the second plate part, wherein the second cooling channel has a third channel portion which is connected to the second discharge connection, and a fourth channel portion which is connected to the second supply connection, so that a coolant supplied to the cooling channel via the second supply connection first passes through the fourth channel portion and then passes through the third channel portion, wherein the third channel portion extends in the third plate part and the fourth channel portion extends in the fourth plate part.

19. The cooling arrangement according to claim 5, wherein the first cooling channel has a first channel portion, which is connected to the first supply connection, in particular via the first fluid line branch, and has a second channel portion, which is connected to the first discharge connection, in particular via the third fluid line branch, so that a coolant supplied to the first cooling channel via the supply connection first passes through the first channel portion and then through the second channel portion, wherein the first channel portion extends in the first plate part and the second channel portion extends in the second plate part, wherein the second cooling channel has a third channel portion which is connected to the second discharge connection, and a fourth channel portion which is connected to the second supply connection, so that a coolant supplied to the cooling channel via the second supply connection first passes through the fourth channel portion and then passes through the third channel portion, wherein the third channel portion extends in the third plate part and the fourth channel portion extends in the fourth plate part.

20. The cooling arrangement according to claim 1, wherein the first supply connection is arranged in the first plate part and the first discharge connection is arranged in the second plate part, the second supply connection is arranged in the fourth plate part and the second discharge connection is arranged in the third plate part.
